(19) United States
(12) Patent Application Publication
(10) Pub. No.: US 2026/0041280 A1
(43) Pub. Date: Feb. 12, 2026

(54) GRINDER WITH FEATURES TO HELP MOVE GROUND SUBSTANCES

(71) Applicant: Rodrigo Escorcio Santos, Rockville, MD (US)

(72) Inventor: Rodrigo Escorcio Santos, Rockville, MD (US)

(21) Appl. No.: 19/290,467

(22) Filed: Aug. 5, 2025

Related U.S. Application Data
(60) Provisional application No. 63/681,247, filed on Aug. 9, 2024.

(51) Int. Cl. A47J 42/26; A47J 42/42

(52) U.S. Cl. CPC A47J 42/26; A47J 42/42

(57) ABSTRACT

A grinder includes a first grinding section and a second grinding section configured to couple to one another. The grinder is configured to receive a substance, and at least one of the first grinding section or the second grinding section includes bumps configured to interact with and grind the substance. The second grinding section includes a sidewall with holes configured to pass the substance through the grinding section.

### CROSS-REFERENCE TO RELATED APPLICATION

This application claims priority to and the benefit of U.S. Provisional Patent Application No. 63/681,247, entitled “GRINDER FOR PLANT SUBSTANCES,” filed Aug. 9, 2024, which is hereby incorporated by reference for all purposes.

### FIELD OF THE INVENTION

The present invention is directed toward a grinder for substances, such as herbs or combustible substances.

### BACKGROUND OF THE INVENTION

Often, substances, such as herbs or combustible substances, are ground into small pieces prior to use (e.g., for cooking, flavoring, and/or or to produce vapors for inhalation). In the specific case of vaporization (or other such combustion techniques), substances may be ground to promote thorough and even combustion. Thus, consumers often use grinders to process substances (i.e., chop, grind, or otherwise reduce in size) prior to use (e.g., prior to combusting a plant substance for inhalation).

Many grinders, regardless of their specific intended use, include teeth that tear or grind a substance when the teeth slide along each other. More specifically, the teeth included in grinders for substances typically extend between opposing surfaces, with some teeth extending from one surface into contact with the other and vice versa. Additionally, the teeth are often arranged to slide by each other when one surface is rotated with respect to the other surface. That is, during such a rotation, the teeth typically slide along each other (at their distal edges or apices) and/or are only separated by very small gaps (between their distal edges or apices), such as gaps of only a few millimeters (“mm”).

The small or nonexistent gaps cause the teeth to grind and/or tear a substance when the teeth are rotated with respect to each other, but the small or nonexistent gaps also cause substances to stick on the teeth. This may waste substances and/or cause the teether to lock up (e.g., after 1-2 mm of ground substance buildup occurs). Wasting substances may be particularly problematic when the substance in the grinder is expensive and/or only available in limited quantities (e.g., due to medical dosing). Additionally, the above-described teeth may generate a large amount of sliding friction, creating resistance forces that require a user to exert a large amount of force when grinding a substance. This resistance only increases as more substances accumulates on the teeth.

### SUMMARY OF THE INVENTION

The systems, apparatuses, methods, and/or features of the present application, as well as advantages thereof, will be, or will become, apparent to one with skill in the art upon examination of the following figures and detailed description. All such systems, methods, features and advantages included within this description are within the scope of the claimed subject matter.

In some embodiments, a grinder includes a first grinding section comprising a first inner surface, a second grinding section configured to couple to the first grinding section, and a plurality of bumps extending from at least one of the first inner surface or the second inner surface. The second grinding section includes a second inner surface and a sidewall extending from the second inner surface to define a receptacle configured to receive a substance, with a plurality of holes formed through the sidewall to enable the substance to pass through the second grinding section. The first grinding section and the second grinding section are configured to rotate relative to one another to cause the plurality of bumps to grind the substance disposed in the receptacle.

In some embodiments, a grinder includes a first grinding section, a second grinding section configured to couple to the first grinding section and receive a substance, and a plurality of bumps formed on the first grinding section and/or the second grinding section to interact with and grind the substance. The second grinding section comprises a sidewall, and the sidewall includes a plurality of holes configured to pass the substance through the second grinding section.

In some embodiments, a grinder includes a grinding section comprising a sidewall configured to receive a substance and a motor configured to operate to promote movement of the substance through the plurality of holes. The sidewall includes a plurality of holes configured to pass the substance through the grinding section.

### BRIEF DESCRIPTION OF THE DRAWINGS

FIG. 1 illustrates a front perspective view of a grinder formed in accordance with an example embodiment of the present invention, identifying the main components of the embodiment.

FIG. 2 illustrates a partially exploded view of a grinder, according to one embodiment.

FIG. 3A illustrates a cross-sectional view of the grinder of FIG. 2 in an assembled configuration.

FIG. 3B illustrates a schematic, side sectional view of grinding sections of the grinder of FIG. 3A, according to one embodiment.

FIG. 4 illustrates a cross-sectional view of another grinder in an assembled configuration, according to one embodiment.

FIG. 5A illustrates a bottom view of a grinding section of a grinder, according to one embodiment.

FIG. 5B illustrates a top view of a grinding section of a grinder, according to one embodiment.

FIG. 5C illustrates a side perspective view of the grinding section of FIG. 5A coupled to the grinding section of FIG. 5B, according to one embodiment.

FIG. 5D illustrates a bottom perspective view of another grinding section of a grinder, according to one embodiment.

FIG. 5E illustrates a top perspective view of yet another grinding section of a grinder, according to one embodiment.

FIG. 5F illustrates a side perspective view of still another grinding section of a grinder, according to one embodiment.

FIGS. 6A-6E illustrate schematic, cross-sectional views of various openings formed through a grinding section of a grinder, according to one embodiment.

FIG. 7A illustrates a front perspective view of a motorized grinder, according to one embodiment.

FIG. 7B illustrates a rear perspective view of the motorized grinder of FIG. 7A.

FIG. 7C illustrates another front perspective view of the motorized grinder of FIGS. 7A and 7B.

FIG. 8 illustrates an exploded view of the motorized grinder of FIGS. 7A-7C.

FIG. 9A illustrates a front perspective view of another motorized grinder, according to one embodiment.

FIG. 9B illustrates a top perspective view of the motorized grinder of FIG. 9A, according to one embodiment.

Like reference numerals have been used to identify like elements throughout this disclosure.

### DETAILED DESCRIPTION

Presented herein are numerous embodiments of a grinder for a substance, such as a plant substance. An earlier version of a manual grinder is disclosed in U.S. Pat. No. 11,690,480, incorporated by reference herein in its entirety. The grinder disclosed herein not only eliminates the teeth used by traditional grinders and replaces these teeth with rounded (e.g. hemispherical) bumps or knobs, but, importantly, it provides holes in the bottom and in the sidewall of the bottom grinding section for filtering substances. Several embodiments of the grinder disclosed herein relate to a small, manual grinder, while other embodiments related to a motorized version of the grinder, which further helps provide ground substances. Features of one embodiment, however, may be readily incorporated into other embodiments.

The embodiments for the grinder disclosed herein include two opposing surfaces, at least one of which includes bumps or knobs, such as hemispherical-shaped bumps, which interacts with a substance to grind the substance into smaller particles. The combination of such bumps or knobs with a new configuration for holes through which substances ground and filtered, in part, forms a basis for some of the disclosed grinder embodiments.

In particular, the grinder includes two grinding sections having the opposing surfaces. One of the grinding sections includes a sidewall extending from its surface. The sidewall includes holes that allow the substances to pass through the grinding section. Thus, the holes prevent or at least discourage the substance from getting stuck on the sidewall, thereby increasing the amount of substance passing through the grinding section. Accordingly, embodiments of the present disclosure minimize waste by reducing or eliminating build-up of substances within the grinding section. In certain embodiments, a motor operates to grind the substances. For instance, the motor may rotate a rotor that passes the substances against the bumps to grind the substances. Additionally or alternatively, the motor vibrates to agitate the substances and promote movement of the substances through the grinder, such as through the holes. Therefore, the motor may increase production of ground substances.

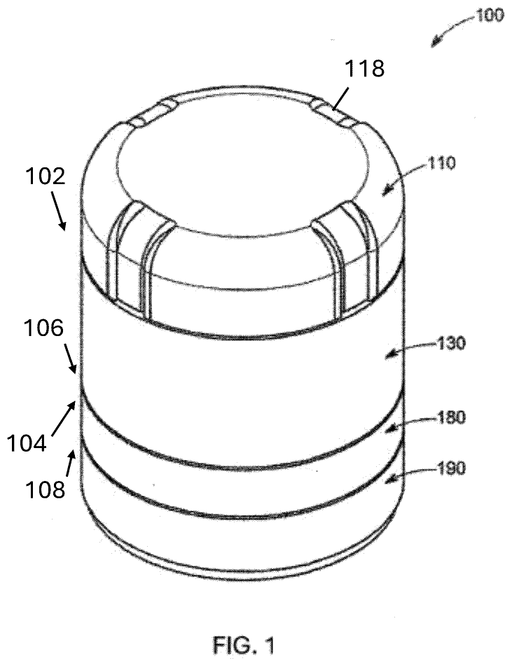

FIGS. 1, 2, 3A, and 3B each illustrate a grinder 100 formed in accordance with the techniques presented herein. FIG. 1 is a front perspective view of the grinder 100. The grinder 100 includes a top/first grinding section 110, a bottom/second grinding section 130, a sieve 180, and a catcher 190. The top grinding section 110 is removably coupled to a first side 102 (e.g., a top side) of the bottom grinding section 130 while a second side 104 (e.g., a bottom side), opposite the first side 102, of the bottom grinding section 130 is removably coupled to a first side 106 (e.g., a top side) of the sieve 180. Thus, the bottom grinding section 130 may be sandwiched between the top grinding section 110 and the sieve 180. Then, the catcher 190 may be removably coupled to a second side 108 (e.g., a bottom side) of the sieve 180 to fully assembled the grinder 100. The top grinding section 110, the bottom grinding section 130, the sieve 180, and the catcher 190 may be removably coupled to one another in any manner, such as via threads, via a friction fit, and/or via a magnet.

The top grinding section 110 is configured to rotate relative to the bottom grinding section 130. In particular, a manually applied force/torque drives the top grinding section 110 and the bottom grinding section 130 to rotate relative to one another. For this reason, the top grinding section 110 of the illustrated grinder 100 has formations 118, such as indents and/or channels, that may be gripped by a user to apply a sufficient force to drive the top grinding section 110 to rotate relative to the bottom grinding section 130. Because the top grinding section 110 and the bottom grinding section 130 are configured to rotate relative to one another in response to a manually applied force, the grinder 100 may be considered a manual grinder.

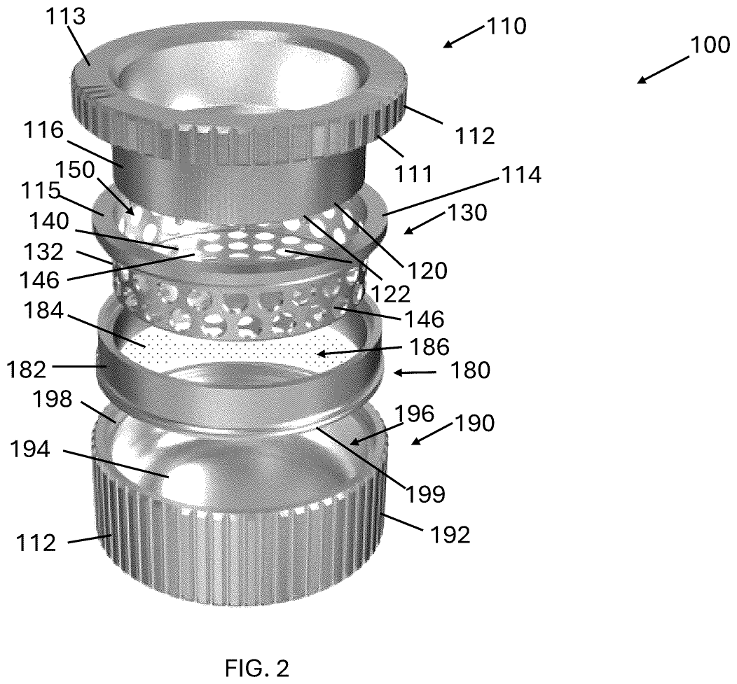

FIG. 2 shows an exploded view of the grinder 100 with the top grinding section 110, the bottom grinding section 130, the sieve 180, and the catcher 190 uncoupled from each other. FIG. 2 also shows an embodiment that differs from that of FIG. 1, at least in part, due to a different type of grip sections 112 on the top grinding section 110, as well as on the catcher 190. As is shown, in at least some embodiments, the grip section 112 may have grooves and an ergonomic shape to enable easy gripping and rotation of the top grinding section 110 relative to the bottom grinding section 130. The top grinding section 110 has a first top outer surface 113 and a first sidewall 116 that extends away from the first top outer surface 113, towards the bottom grinding section 130. A first inner surface 120 extends radially inward from the first sidewall 116, while the first top outer surface 113 extends radially outward from the first sidewall 116, thereby forming a first/top shoulder 111 of the top grinding section 110.

The bottom grinding section 130 includes a second sidewall 132 extending from a second inner surface 140 to define a receptacle 150. A second top/outer surface 115 extends radially outward from the second sidewall 132 to form a second/bottom shoulder 114 of the bottom grinding section 130. Coupling the top grinding section 110 to the bottom grinding section 130 inserts the first sidewall 116 of the top grinding section 110 into the receptacle 150 of the bottom grinding section 130 and engages the first shoulder 111 of the top grinding section 110 to the second shoulder 114 of the bottom grinding section 130. Consequently, the first inner surface 120 and the second inner surface 140 face one another. The top grinding section 110 is configured to rotate relative to the bottom grinding section 130. To this end, in at least some embodiments, the second shoulder 114 may include grooves (e.g., a track) that allow the first shoulder 111 to ride on and/or seal against the second shoulder 114 of the bottom grinding section 130.

In other embodiments, the top grinding section 110 need not include the first shoulder 111 and/or need not be sized to fit into the bottom grinding section 130. For example, the top grinding section 110 may be coupled to the bottom grinding section 130 without inserting the first sidewall 116 into the receptacle 150 to engage the shoulders 111, 114 against one another. In further embodiments, the top grinding section 110 may be coupled to the bottom grinding section 130 by inserting the first sidewall 116 into the receptacle 150 but without having to engage the shoulders 111, 114 against one another.

In any case, the top grinding section 110 includes first bumps/knobs 122 extending away from the first inner surface 120. The bumps first 122 are configured to grind substances positioned between the first inner surface 120 and the second inner surface 140 (e.g., within the receptacle 150). For instance, rotating the top grinding section 110 relative to the bottom grinding section 130 may cause the first bumps 122 to interact with the substances and apply a force that breaks the substances into smaller pieces.

The bottom grinding section 130 includes holes 146 formed through the second inner surface 140 and the second sidewall 132. The holes 146 are configured to pass ground substances through the bottom grinding section 130. For example, coupling the top grinding section 110 to the second grinding section 130 may position the first inner surface 120 to extend alongside the second inner surface 140 and therefore the holes 146 formed through the second inner surface 140, while and also positioning the first sidewall 116 to extend alongside the second sidewall 132 and therefore the holes 146 formed through the second sidewall 132. Thus, ground substances disposed in the receptacle 150 between the first inner surface 120 and the second inner surface 140 and/or between the first sidewall 116 and the second sidewall 132 may pass through the holes 146. The holes 146 direct ground substances toward the sieve 180.

The sieve 180 may be or act as a filter to regulate the size of ground substances that can pass into the catcher 190. In the depicted embodiment, the sieve 180 includes a third sidewall 182 and a filter 184 on the underside of the sieve 180 spanning the interior circumference of the third sidewall 182. The third sidewall 182 defines an opening 186 configured to receive the second sidewall 132 of the bottom grinding section 130. The second shoulder 114 of the bottom grinding section 130 is configured to engage the third sidewall 182 to couple the bottom grinding section 130 to the sieve 180. In some embodiments, the third sidewall 182 includes features, such as threads, that further help couple the sieve 180 to the bottom grinding section 130 (e.g., to corresponding threads of the second sidewall 132).

The filter 184 filters the ground substances by allowing ground substances smaller than a threshold size (e.g., volume, cross-sectional area), such as a fine powdered version (e.g., crystals and/or trichomes) of the substances, to pass therethrough. That is, the filter 184 may block ground substances greater than a threshold size from passing through.

The catcher 190 is separate from the sieve 180 in the depicted embodiment and includes a fourth sidewall 192 and a receiving surface 194 extending radially inward from the fourth sidewall 192 to define a receptacle 196. The receptacle 196 is configured to receive the ground substances passing through the filter 184 of the sieve 180. The catcher 190 collects such particles of ground substances and is removably coupled to the sieve 180 to enable the ground substance particles to be retrieved.

As an example, the receptacle 196 may be configured to receive a portion of the third sidewall 182. For instance, a lip 198 may extend radially inward from the fourth sidewall 192 into the receptacle 196 and may be configured to abut an edge 199 of the third sidewall 182. In some embodiments, the fourth sidewall 192 includes features, such as threads, that further help couple the catcher 190 to the sieve 180 (e.g., to corresponding threads of the third sidewall 182).

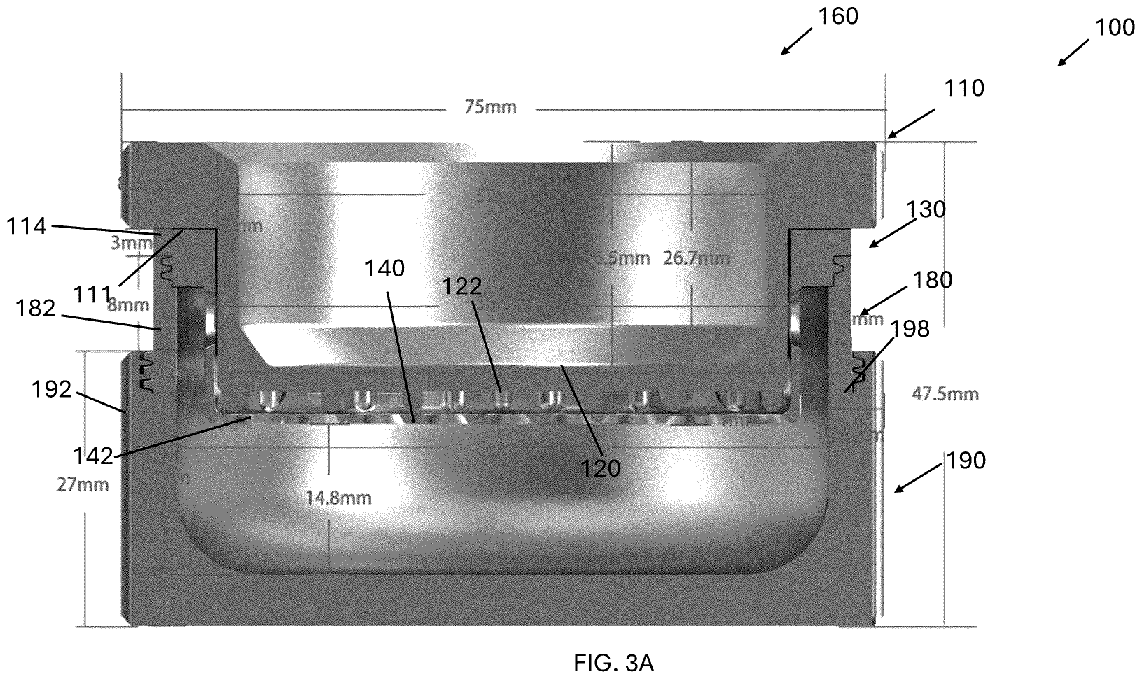

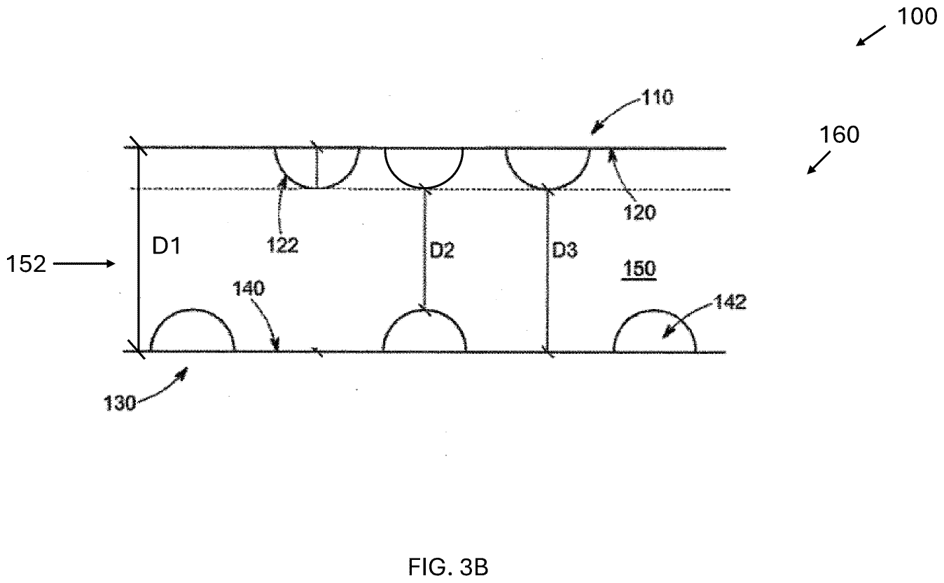

FIG. 3A is a cross-sectional view of the grinder 100 in an assembled configuration 160 in which the top grinding section 110, the bottom grinding section 130, the sieve 180, and the catcher 190 are coupled to one another. Specifically, the first shoulder 111 of the top grinding section 110 engages the second shoulder 114 of the bottom grinding section 130, the second shoulder 114 engages the third sidewall 182 of the sieve 180, and the third sidewall 182 engages the lip 198 and the fourth sidewall 192 of the catcher 190. In the assembled configuration, the first bumps 122 of the top grinding section 110 extend toward corresponding second bumps 142 on the second inner surface 140 of the bottom grinding section 130. Thus, rotating the top grinding section 110 relative to the bottom grinding section 130 causes the first bumps 122 and the second bumps 142 to interact with and apply a force against substances disposed between the first inner surface 120 and the second inner surface 140.

As is shown, the grinder 100 has a cylindrical shape in the assembled configuration 160. However, this is merely an example, and other embodiments may have any desirable shape or shapes. Moreover, other embodiments may have any number of sieves 180 (e.g., zero, one, two, or more) to provide different levels of filtering between the bottom grinding section 130 and the catcher 190, so as to capture different sized pieces of ground substances in different locations. Still further, some embodiments need not include the catcher 190 and/or sieve 180 as separate parts and any combination of these parts, or the functions thereof, could be built directly into the bottom grinding section 130.

FIG. 3B illustrates a schematic, cross-sectional view of the grinder 100 in the assembled configuration 160, specifically showing an arrangement of the top grinding section 110 and the bottom grinding section 130. The top grinding section 110 and the bottom grinding section 130 collectively form a chamber or receptacle 150, in which a substance can be received. Critically, at least one of the top grinding section 110 or the bottom grinding section 130 includes a surface with bumps or knobs that extend into the receptacle 150. However, for simplicity and brevity, FIG. 3B illustrates an embodiment where the top grinding section 110 includes the first bumps 122 extending from the first inner surface 120 and the bottom grinding section 130 includes the second bumps 142 extending from the second inner surface 140. Bumps 122 and 142 each extend into the receptacle 150 but do not contact one another, according to one embodiment. Thus, the first bumps 122 do not create frictional resistance for the second bumps 142 and vice versa.

The arrangement of the bumps 122, 142 defines a longitudinal gap extending between the inner surfaces 120, 140, which are shown as being substantially flat or planar. The longitudinal gap 152 varies in size based on the relative placement of the bumps 122, 142. For example, the longitudinal gap 152 may span a first (larger) longitudinal distance D1 from the first inner surface 120 to the second inner surface 140 at portions where each of the top grinding section 110 and the bottom grinding section 130 do not have bumps 122, 142, respectively. The longitudinal gap 152 spans a second (smaller) longitudinal distance D2 from an apex of one of the first bumps 122 to an apex of one of the second bumps 142 at portions where the top grinding section 110 and the bottom grinding section 130 have aligned bumps 122, 142. The longitudinal gap 152 spans an third (intermediate) longitudinal distance D3 from an apex of one of the first bumps 122 to the second inner surface 140 at portions where the top grinding section 110 has a first bump 122 but the bottom grinding section 130 does not have a second bump 142.

In some embodiments, the third longitudinal distance D3 and/or the second longitudinal distance D2 may be equal to or less than approximately 50% of the overall longitudinal distance D1 of the receptacle 150. Alternatively, the third longitudinal distance D3 and/or the second longitudinal distance D2 may be equal to or less than approximately 60%, approximately 75%, approximately 85%, or approximately 90% of the first longitudinal distance D1. As a specific example, the second longitudinal distance D2 may be approximately 3 mm, the first longitudinal distance D1 may be approximately 6 mm, and the third longitudinal distance D3 may be approximately 4.5 mm. In any case, providing the longitudinal gap 152 between bumps 122, 142 may ensure that the bumps 122, 142 do not generate frictions with another surface of the grinder 100 and create resistance forces that require a user to exert a large amount of force when grinding a substance. Instead, the bumps 122, 142 encourage rolling friction between the substance and the bumps 122, 142 so that the substance is ground into pieces small enough to pass through the holes 146 of the bottom grinding section 130.

However, to be clear, the embodiment depicted in FIG. 3A is only an example and is not intended to be limiting. For example, in different embodiments, the first inner surface 120 and/or second inner surface 140 need not be flat and could still incorporate bumps with longitudinal gaps disposed there above. In some embodiments, the first inner surface 120 and second inner surface 140 could each be concave, convex, or irregularly shaped and still implement the concepts presented herein. Likewise, the bumps 122 and/or bumps 142 need not be hemispherical and may be rounded in any manner to encourage rolling friction. Furthermore, one of the top grinding section 110 or the bottom grinding section 130 may not include bumps. Still further, the apices of bumps 122 and 142, as well as the inner surfaces 120 and 140 of the grinding sections 110 and 130 may be spaced apart by any amount of space, and such a space may vary across a single embodiment (e.g., by varying sizes or shapes of bumps and/or by providing a non-flat surface).

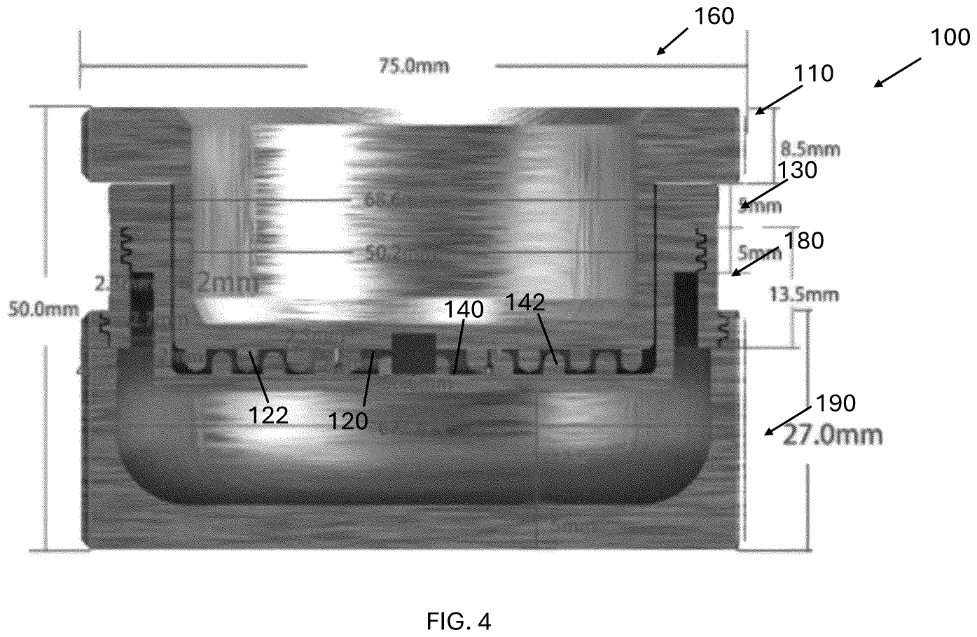

FIG. 4 is a cross-sectional view of another embodiment of the grinder 100 in the assembled configuration 160. The illustrated grinder 100 has a similar arrangement as the embodiment shown in FIG. 3A with the top grinding section 110, the bottom grinding section 130, the sieve 180, and the catcher 190 coupled to one another. However, the first bumps 122 of the top grinding section 110 and the second bumps 142 of the bottom grinding section 130 have a different arrangement than shown in FIG. 3A. In particular, the bumps 122, 142 extend alongside one another. For example, the first bumps 122 may be offset from one another to define spaces between adjacent first bumps 122, and each second bump 142 is configured to extend into one of the spaces formed between adjacent first bumps 122. Similarly, the second bumps 142 may be offset from one another to define spaces between adjacent second bumps 142, and each first bump 122 is configured to extend into one of the spaces formed between adjacent second bumps 142. Consequently, the bumps 122, 142 are positioned such that rotating the top grinding section 110 relative to the bottom grinding section 130 slides the first bumps 122 past the second bumps 142 to grind substances disposed between the first inner surface 120 of the top grinding section 110 and the second inner surface 140 of the bottom grinding section 130.

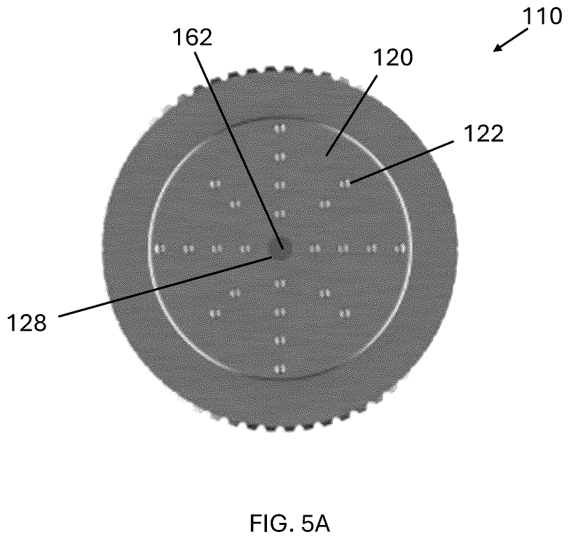

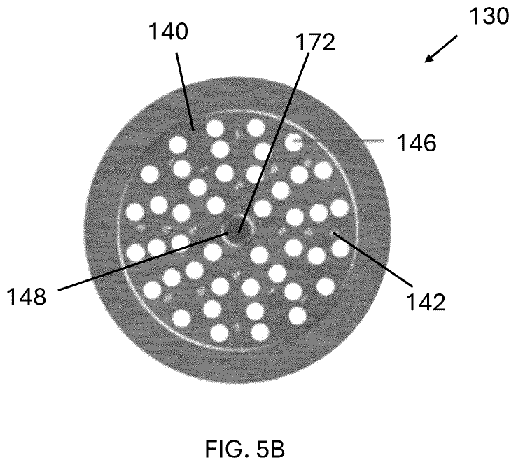

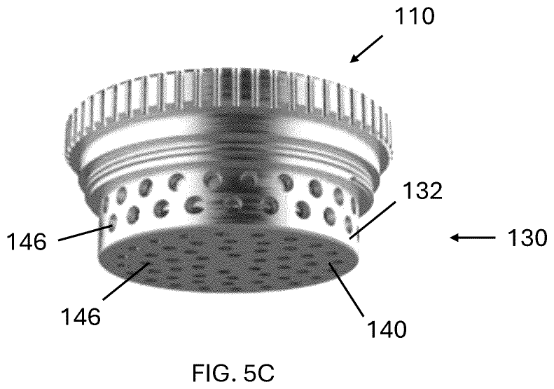

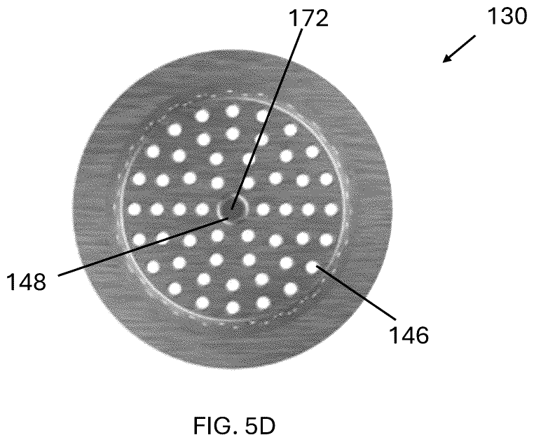

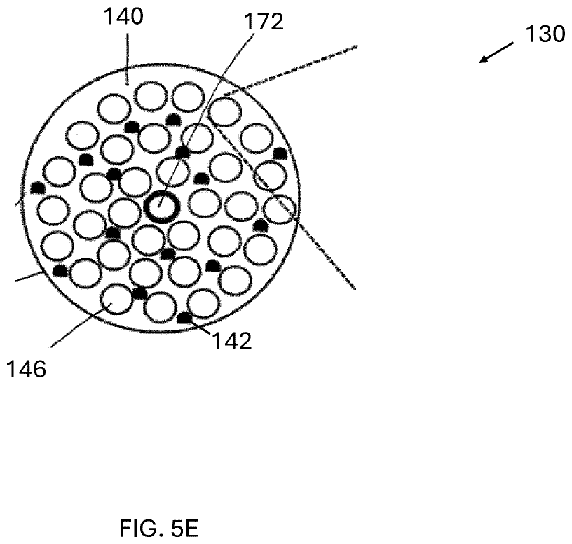

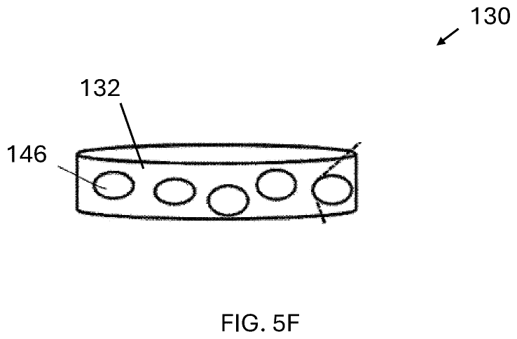

FIG. 5A is a bottom view of the top grinding section 110 illustrating a possible arrangement of the first bumps 122 on the first inner surface 120, such as for the arrangement illustrated in FIG. 3A and/or in FIG. 4. In particular, the first bumps 122 are included on radial lines that extend from a center 162 of the first inner surface 120, patterned so that the lines alternate between including one bump or two bumps. This creates an arrangement where the first bumps 122 are symmetrical across the first inner surface 120 when viewed with respect to multiple diameters of the top grinding section 110. However, the depicted arrangement of the first bumps 122 is just one arrangement and, in other embodiments, the first bumps 122 may be patterned or arranged in any other manner.

The top grinding section 110 also includes a first magnet 128 positioned at the center 162 of the top grinding section 110. As further discussed herein, the first magnet 128 helps magnetically couple the top grinding section 110 to the bottom grinding section 130.

FIG. 5B is a top view of the bottom grinding section 130 illustrating a possible arrangement of the second bumps 142 on the second inner surface 140 and of the holes 146 formed through the second inner surface 140, such as for the arrangement illustrated in FIG. 3A and/or in FIG. 4. The second bumps 142 are generally positioned circumferentially about a center 172 of the second inner surface 140 between the holes 146, but in additional or alternative embodiments, the second bumps 142 are space linearly across at least a portion of the second inner surface 140. Further, in other embodiments, the second bumps 142 are evenly spaced between the holes 146. There is a sufficient quantity of holes 146 distributed along the second inner surface 140 to enable ground substances to be directed through the bottom grinding section 130 (e.g., toward the sieve 180). However, the depicted arrangement of the second bumps 142 and holes 146 is just one arrangement and, in other embodiments, the second bumps 142 and holes 146 may be patterned or arranged in any other manner. For instance, the pattern of the second bumps 142 need not match the pattern of the first bumps 122.

The bottom grinding section 130 includes a second magnet 148 positioned at the center 172 of the bottom grinding section 130. The second magnet 148 is magnetically attracted to the first magnet 128 to magnetically couple the top grinding section 110 to the bottom grinding section 130. In some embodiments, the second magnet 148 extends past the second bumps 142 and/or the first magnet 128 extends past the first bumps 122. For example, the first magnet 128 may be configured to contact the second magnet 148 while keeping the bumps 122, 142 from contacting one another. As an example, the first bumps 122 and/or the second bumps 142 may have a longitudinal dimension (i.e., height) of approximately 1.5 mm, and the first magnet 128 and/or the second magnet 148 may have a longitudinal dimension of approximately 3 mm.

To be clear, the combination of the first magnet 128 and the second magnet 148 is only an example of a feature that can removably couple the top grinding section 110 to the bottom grinding section 130. In other embodiments, the bottom grinding section 130 and/or the top grinding section 110 can include any number of components that allow removable coupling, in addition to or in lieu of magnets, arranged in any arrangement.

FIG. 5C is a perspective side perspective view of the top grinding section 110 coupled to the bottom grinding section 130. The illustrated bottom grinding section 130 includes the holes 146 formed through the second inner surface 140, as well as through the second sidewall 132. Consequently, ground substances can pass through both the second inner surface 140 and the second sidewall 132 to move toward the sieve 180. Forming the holes 146 through the second sidewall 132 may enable more efficient collection of ground substances at the catcher 190. Specifically, there is an increased amount of surface area of the holes 146 to enable the ground substances to move through the bottom grinding section 130. Additionally, the holes 146 formed through the second sidewall 132 in particular prevent or at least discourage substances from becoming stuck along the second sidewall 132 instead of moving through the bottom grinding section 130. Therefore, the illustrated bottom grinding section 130 may enable a greater amount (e.g., volume, weight) of substances to be collected by the catcher 190. The holes 146 are formed through the illustrated second sidewall 132 along two separate rows about a circumference of the second sidewall 132.

FIG. 5D is a bottom view of another embodiment of the bottom grinding section 130 illustrating a possible arrangement of the holes 146 formed through the second inner surface 140, such as circumferentially about the center 172. The holes 146 of the bottom grinding section 130 of FIG. 5D are smaller than the holes 146 of the bottom grinding section 130 of FIG. 5B. However, there is a greater quantity of the holes 146 of the bottom grinding section 130 of FIG. 5D compared to the quantity of the holes 146 of the bottom grinding section 130 of FIG. 5B. Thus, an overall area occupied by the holes 146 of the bottom grinding section 130 of FIG. 5D may be comparable to the overall area occupied by the holes 146 of the bottom grinding section 130 of FIG. 5B and may therefore adequately enable substances to be directed through the bottom grinding section 130.

FIG. 5E is a top view of yet another embodiment of the bottom grinding section 130 illustrating a possible arrangement of the holes 146 formed through the second inner surface 140. In particular, the holes 146 are positioned circumferentially about the center 172. Additionally, the second bumps 142 are distributed in a more randomized manner on the second inner surface 140 between the holes 146. For instance, the second bumps 142 may not be disposed circumferentially about the center 172 or at radially lines extending from the center 172.

FIG. 5F is a side perspective view of the bottom grinding section 130 showing a further arrangement of the holes 146 formed through the second sidewall 132. The illustrated holes 146 are distributed unevenly (e.g., non-linearly) about a circumference of the second sidewall 132.

Each illustrated hole 146 of the bottom grinding section 130 is substantially circular with diameters that may range from less than about 2 mm, to between about 2 mm to about 3 mm, about 3 mm to about 4 mm, about 4 mm to about 5 mm, about 5 mm to about 6 mm, or about 6 mm to about 7 mm. However, in other embodiments the holes 146 may be oblong or any other suitable shape. Additionally, the holes 146 may be distributed in any suitable manner along the second inner surface 140 and/or along the second sidewall 132 to enable ground substances to pass through the bottom grinding section 130.

In some embodiments, the second sidewall 132 is positioned generally at a right angle to the second inner surface 140, meaning that the second sidewall 132, when located in some disclosed embodiments, extends substantially vertically, while the second inner surface 140 extends substantially horizontally. The terms “substantially vertical” or “substantially horizontal” encompass this relative positioning and shapes of the components, but these terms also encompass embodiments in which there may exist some curvature in either the second sidewall 132 or the second inner surface 140, or a broadening of the angle to between about 91 to about 165 degrees, or reducing the angle down to about 70 or 75 degrees between the two, such that a skilled artisan may refer to the positioning of one component (e.g., the second sidewall 132) relative to another component (e.g., the second inner surface 140) as “substantially vertical” or “substantially horizontal.” For example, in some embodiments, the bottom grinding section 130 could take on more of a rounded or basket-like shape, with a slightly bulging sidewall and/or a slightly sagging second inner surface 140. Similar modifications to the top grinding section 110 would also be required for a proper fit of the two components, but grinding according to the disclosed embodiments could nonetheless take place in such a shaped vessel. In another embodiment, the angle between the second sidewall 132 and second inner surface 140 is made somewhat smaller than 90 degrees, with a corresponding change in the top grinding section 110 dimensions to enable full functioning of the grinder 100. In still other embodiments the angle, whether larger or smaller than 90 degrees, is rounded to avoid any sharp cutting surfaces.

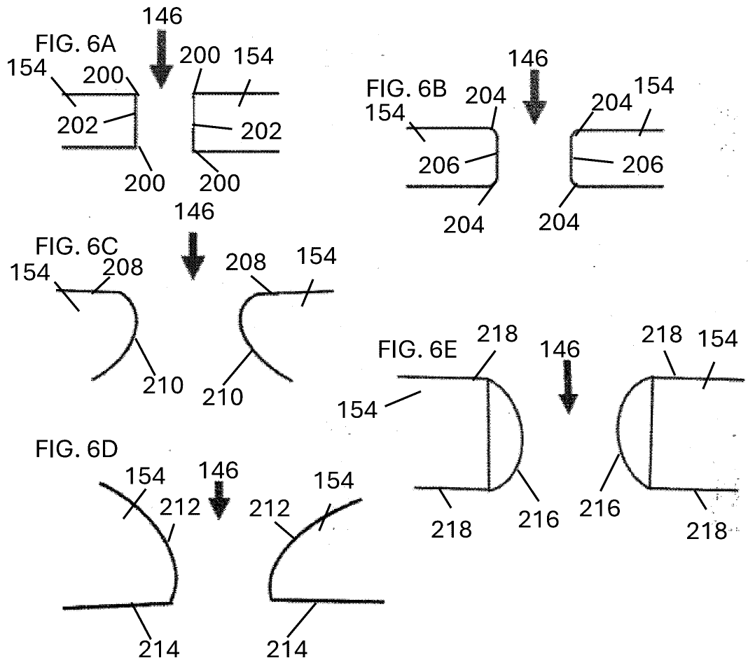

FIGS. 6A-6E each show, schematically, various configurations for the holes 146 of the bottom grinding section 130. In particular, FIGS. 6A-6E represent cross-sectional views of a respective hole 146 formed through a wall/surface 154, such as the second sidewall 132 or the second inner surface 140. FIG. 6A illustrates the wall 154 having sharp edges 200, as well as a substantially planar face 202 extending between the sharp edges 200 and surrounding the hole 146. FIG. 6B illustrates the wall 154 having rounded edges 204 with a substantially planar face 206 extending between the rounded edges 204 and surrounding the hole 146. FIG. 6C illustrates the wall 154 having an initial planar face 208 (i.e., an upstream face), which transitions to an arcuate face 210 (i.e., a downstream face) that tapers outward. In contrast, FIG. 6D illustrates the wall 154 having an initial arcuate face 212 (i.e., an upstream face) that tapers inward and transitions to a planar face 214 (i.e., a downstream face). FIG. 6E illustrates the wall 154 having an arcuate face 216 (e.g., having a semicircular shape) surrounding the hole 146 and extending between planar faces 218. Each of these illustrated configurations may provide desirable shapes and features for the holes 146 to permit ground substances to pass through the bottom grinding section 130. For instance, the rounded edges 204 and/or the arcuate faces 210, 212, 216 may allow ground substances to move smoothly through the hole 146, such as without imparting a force that may alter a structure of the ground substances.

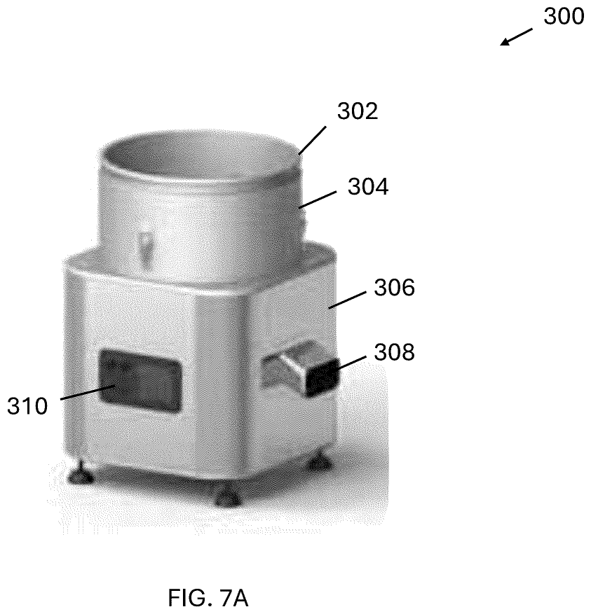

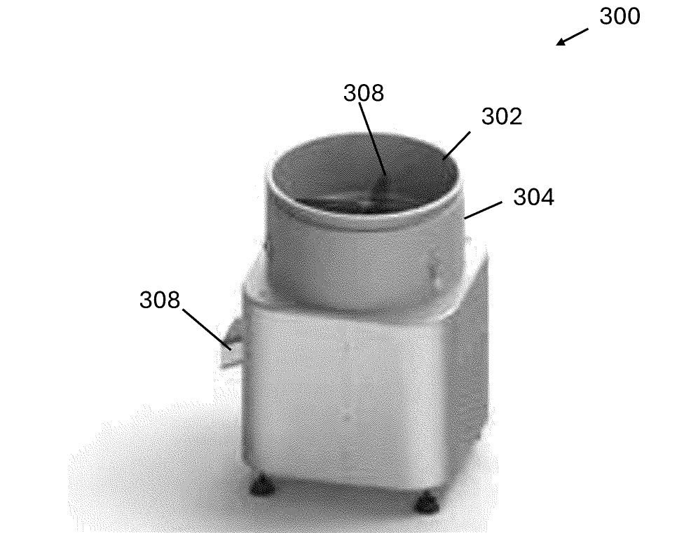

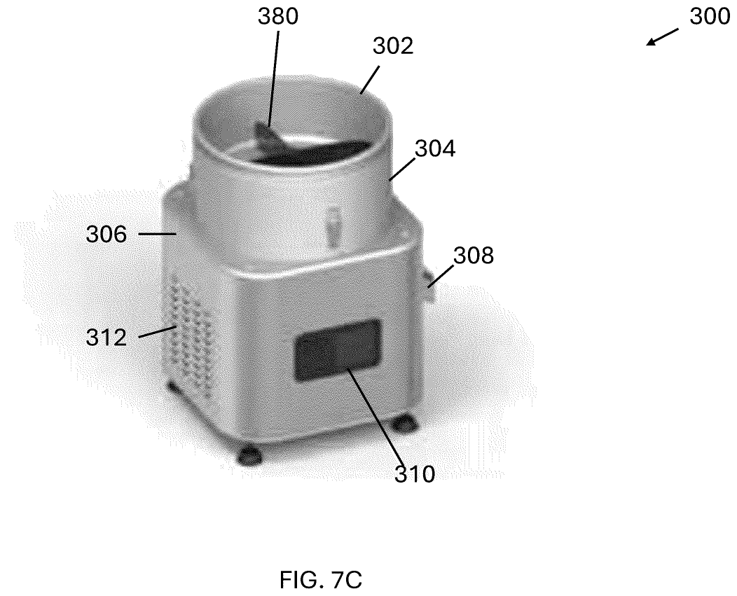

FIGS. 7A-7C are perspective views of a grinder 300, which is motorized to help grind substances. FIG. 7A is a front perspective view of the grinder 300, which may be used for grinding larger amounts of substances, such as for commercial or dispensary use. The grinder 300 includes a top/first grinding section 302 and a bottom/second grinding section 304 coupled to one another. The top grinding section 302 and the bottom grinding section 304 may be similar to the top grinding section 110 and the bottom grinding section 130, respectively, of the grinder 100 and therefore may provide similar features. Thus, description regarding the top grinding section 110 and the bottom grinding section 130 may be similarly applied to the top grinding section 302 and the bottom grinding section 304. The grinder 300 also includes a housing 306 coupled to the bottom grinding section 304, an exit chute 308 extending out of the housing 306, and a user interface 310 formed on a part of the housing 306. Substances may be disposed between the top grinding section 110 and the bottom grinding section 130, and a motor (not shown) disposed in the housing 306 is configured to activate to grind the substances. The ground substances pass through the bottom grinding section 304 to the housing 306, where the exit chute 308 is configured to discharge ground substances out of the housing 306.

Additionally or alternatively, the motor is configured to vibrate to agitate the ground substances within the grinder 300 (e.g., between the top grinding section 302 and the bottom grinding section 304, within the housing 306). Agitating the ground substances may prevent or at least discourage the ground substances from sticking to a surface (e.g., of the bottom grinding section 304, of the housing 306) and instead, to move toward the exit chute 308. As an example, the motor vibrates the bottom grinding section 304 to encourage the ground substances to move through holes formed through the bottom grinding section 304. Therefore, the motor helps the grinder 300 operate efficiently to provide ground substances. That said, in other embodiments, a motor may drive rotational movement of one or more grinding sections and a separate vibration mechanism may vibrate one or more grinding sections.

In some embodiments, the user interface 310 may be used to initiate and/or suspend operation of the grinder 300. For instance, a user may interact with the user interface 310 to initiate operation of the motor to grind substances and/or to vibrate the grinder 300. The user may also interact with the user interface 310 to suspend operation of the motor. Therefore, the user interface 310 enables the user to selectively operate the grinder 300.

FIG. 7B is a rear perspective view of the grinder 300 also showing a rotor 380 (e.g., a rotating lever) disposed within the top grinding section 302. The motor is configured to rotate the rotor 380 around a pivot, which enables the rotor 380 to interact with and grind substances that are then passed to the bottom grinding section 304 and toward the exit chute 308. In various embodiments, the rotor 380 may have two or more arms, e.g., up to 6 arms, and in some embodiments, may have bumps to help grind substances.

FIG. 7C is another front perspective view of the grinder 300, illustrating an air inlet 312 formed through a portion of the housing 306. The air inlet 312 is configured to circulate air through the housing 306 to cool the motor and other components of the grinder 300. By way of example, the grinder 300 may include a fan (not shown) configured to activate during operation of the grinder 300 to direct air into the housing 306 via the air inlet 312.

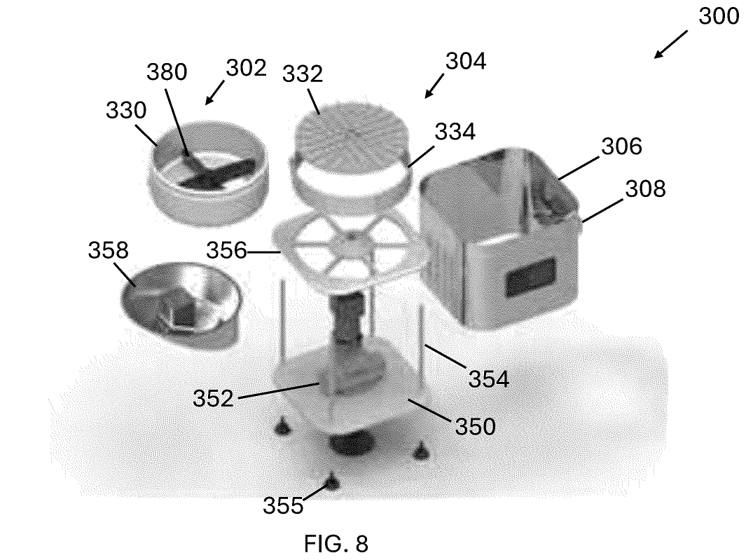

FIG. 8 is an exploded view of the grinder 300. In particular, FIG. 8 illustrates the top grinding section 302 separated from the bottom grinding section 304, which are each separated from the housing 306. The top grinding section 302 includes a first sidewall 330 in which the rotor 380 is configured to be disposed. Meanwhile, the bottom grinding section 304 includes an inner plate 332 with formations to help grind substances and pass ground substances to the sieve 356. Such formations may include any of the bumps (e.g., the first bumps 122, the second bumps 142) and/or holes (e.g., the holes 146) discussed herein. The inner plate 332 is configured to be disposed within a second sidewall 334. The first sidewall 330 and the second sidewall 334 are configured to couple to one another to couple the top grinding section 302 and the bottom grinding section 304 to one another. To be clear, in at least some embodiments, the first sidewall 330 and/or the second sidewall 334 may include the holes shown and described herein.

The housing 306 is shown separate from a base 350, which supports the motor 352 configured to rotate the rotor 380. Support columns 354 extend at outer portions (e.g., corners) of the base 350 and are configured to help couple the housing 306 to the base 350. The base 350 is further elevated by feet 355. A sieve 356 is configured to couple to the housing 306 to receive ground substances from the bottom grinding section 304 and filter the received ground substances. Additionally, a catcher 358 is configured to receive ground substances filtered by the sieve 356 and direct the filtered ground substances toward the exit chute 308.

The motor 352 is mechanically linked to the rotor 380 to rotate the rotor 380 within the top grinding section 302, which pushes substances over and around the formations of the inner plate 332, thereby grinding substances. In some embodiments, operation of the motor 352 vibrates the grinder 300 (e.g., the bottom grinding section 304) to help move ground substances through the grinder 300, such as through holes formed in the inner plate 332 and/or the second sidewall 334 of the bottom grinding section 304, and toward the exit chute 308. The motor 352 of the grinder 300 can be any commercially available motor known now or in the future that is capable of rotating the rotor 380. Additionally, the motor 352 can receive power from any energy source currently known now or that will be known in the future, e.g., solar, hydro, electric, fuel, battery, etc. To reiterate, however, in other embodiments, a vibration mechanism separate from the motor 352 may vibrate one or more grinding sections.

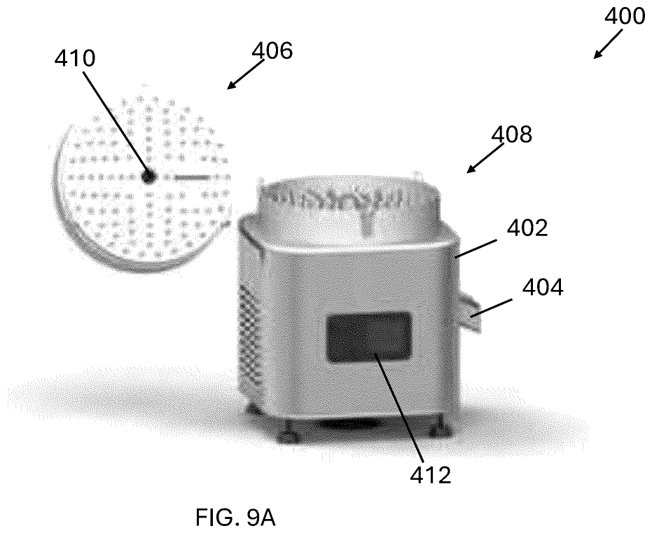

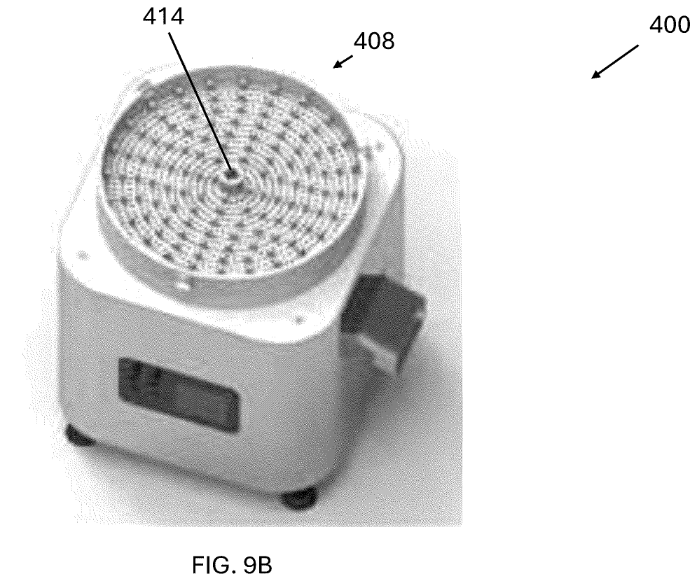

FIG. 9A is a front perspective view of an embodiment of another grinder 400, which may be motorized. Similar to the grinder 300, the grinder 400 includes a housing 402 and an exit chut 404 extending out of the housing 402. The grinder 400 also includes a motor (not shown) disposed in the housing 402. However, the grinder 400 does not utilize a rotor for grinding substances.

The grinder 400 includes a top/first grinding section 406 and a bottom/second grinding section 408, which are separated from one another in FIG. 9A, with the underside of the top grinding section 406 visible. The top grinding section 406 and the bottom grinding section 408 are configured to rotate relative to one another. By way of example, the top grinding section 406 and the bottom grinding section 408 may operate similarly to the top grinding section 110 and the bottom grinding section 130 of the grinder 100. To this end, each of the top grinding section 406 and the bottom grinding section 408 may include formations, such as bumps (e.g., similar to the first bumps 122, similar to the second bumps 142), configured to grind substances. The top grinding section 406 includes a first coupler 410 (e.g., a first magnet, a first mount) configured to couple to the bottom grinding section 408.

Additionally, the motor is configured to vibrate and/or rotate the bottom grinding section 408 to encourage ground substances to move through the grinder 400, such as through the bottom grinding section 408. Additionally or alternatively, a vibration mechanism separate from the motor 352 may vibrate one or more grinding sections. In any case, the grinder 400 includes a user interface 412, which may be used to selectively operate the motor, vibrate the grinder 400, and/or to control any other operations of the grinder 400.

FIG. 9B is a top perspective view of the grinder 400, further illustrating the bottom grinding section 408 (e.g., a top side of the bottom grinding section 408). The bottom grinding section 408 includes a second coupler 414 (e.g., a second magnet, a second mount) configured to couple to the first coupler 410 to removably couple the top grinding section 406 and the bottom grinding section 408 to one another, while permitting the top grinding section 406 and the bottom grinding section 408 to rotate relative to one another to grind substances.

In some embodiments, a portion (e.g., a shaft) of the motor extends through the top grinding section 406 and the bottom grinding section 408 to help couple the top grinding section 406 and the bottom grinding section 408 to one another. For example, each of the top grinding section 406 and the bottom grinding section 408 are configured to couple to the portion of the motor. The couplers 410, 414 secure the top grinding section 406 and the bottom grinding section 408 to one another, such as via a magnetic attraction, to supplement the coupling provided by the motor. In other embodiments, however, no couplers 410, 414 are used to removably couple the top grinding section 406 and the bottom grinding section 408 to one another. Instead, gravitational and/or centripetal forces may sufficiently couple the top grinding section 406 and the bottom grinding section 408 to one another during operation.

More generally, while the embodiments of the grinders 100, 300, 400 presented herein have been illustrated and described in detail and with reference to specific components, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

It is also to be understood that the grinder embodiments of the present invention, or portions thereof, may be fabricated from any suitable material or combination of materials, provided that the device, or portions thereof, can function as described herein (e.g., to form sealed connections). Example materials include plastic, foamed plastic, wood, cardboard, pressed paper, metal, supple natural or synthetic materials including, but not limited to, cotton, elastomers, polyester, plastic, rubber, derivatives thereof, and combinations thereof. Suitable plastics may include high-density polyethylene (HDPE), low-density polyethylene (LDPE), polystyrene, acrylonitrile butadiene styrene (ABS), polycarbonate, polyethylene terephthalate (PET), polypropylene, ethylene-vinyl acetate (EVA), or the like. Suitable foamed plastics may include expanded or extruded polystyrene, expanded or extruded polypropylene, EVA foam, derivatives thereof, and combinations thereof.

Additionally, it is intended that the present invention cover the modifications and variations of this invention that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Similarly, where any description recites “a” or “a first” element or the equivalent thereof, such disclosure should be understood to include incorporation of one or more such elements, neither requiring nor excluding two or more such elements. Meanwhile, when used herein, the term “approximately” and terms of its family (such as “approximate,” etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially.”

What is claimed is:

1. A grinder, comprising:
a first grinding section comprising a first inner surface;
a second grinding section configured to couple to the first grinding section, wherein the second grinding section comprises a second inner surface and a sidewall extending from the second inner surface to define a receptacle configured to receive a substance, wherein a plurality of holes is formed through the sidewall to enable the substance to pass through the second grinding section; and
a plurality of bumps extending from at least one of the first inner surface or the second inner surface, wherein the first grinding section and the second grinding section are configured to rotate relative to one another to cause the plurality of bumps to grind the substance disposed in the receptacle.

2. The grinder of claim 1, wherein an additional plurality of holes is formed through the second inner surface to enable the substance to pass through the second grinding section.

3. The grinder of claim 1, wherein the plurality of bumps extends from the first inner surface, and the grinder comprises an additional plurality of bumps extending from the second inner surface.

4. The grinder of claim 3, wherein the plurality of bumps and the additional plurality of bumps extend toward but do not contact one another while the first grinding section and the second grinding section are coupled to one another to form a gap between apices of the plurality of bumps and of the additional plurality of bumps.

5. The grinder of claim 1, comprising a motor configured to vibrate to promote the substance to move through the plurality of holes.

6. The grinder of claim 1, comprising a catcher configured to collect the substance passed through the plurality of holes.

7. The grinder of claim 1, wherein the receptacle of the second grinding section is configured to receive the first inner surface.

8. The grinder of claim 1, wherein the first grinding section comprises an additional sidewall extending from the first inner surface and an outer surface extending radially outward from the additional sidewall to define a shoulder, and the shoulder is configured to engage the second grinding section to extend the additional sidewall alongside the plurality of holes.

9. A grinder, comprising:
a first grinding section;
a second grinding section configured to couple to the first grinding section and receive a substance, wherein the second grinding section comprises a sidewall, and the sidewall comprises a plurality of holes configured to pass the substance through the second grinding section; and
a plurality of bumps formed on the first grinding section and/or the second grinding section to interact with and grind the substance.

10. The grinder of claim 9, comprising a rotor disposed in the first grinding section and configured to rotate to grind the substance in the second grinding section.

11. The grinder of claim 10, wherein the second grinding section comprises a plate configured to couple to the sidewall and having the plurality of bumps, and the rotor is configured to rotate to move the substance against the plurality of bumps and grind the substance.

12. The grinder of claim 10, comprising a motor configured to rotate the rotor.

13. The grinder of claim 12, wherein the motor is configured to vibrate the second grinding section to promote movement of the substance through the plurality of holes.

14. The grinder of claim 9, comprising a sieve coupled to the second grinding section and configured to receive the substance passed through the plurality of holes, wherein the sieve is configured to filter the substance.

15. The grinder of claim 14, wherein the second grinding section comprises an outer surface extending radially outward from the sidewall to define a shoulder, and the shoulder is configured to engage the sieve to couple the second grinding section to the sieve.

16. A grinder, comprising:
a grinding section comprising a sidewall configured to receive a substance, wherein the sidewall comprises a plurality of holes configured to pass the substance through the grinding section; and
a motor configured to operate to promote movement of the substance through the plurality of holes.

17. The grinder of claim 16, wherein the motor is configured to vibrate the grinding section to agitate the substance to promote movement of the substance through the plurality of holes.

18. The grinder of claim 17, comprising a rotor, wherein the motor is configured to rotate the rotor to grind the substance to promote movement of the substance through the plurality of holes.

19. The grinder of claim 18, comprising an additional grinding section comprising an additional sidewall, wherein the additional grinding section is configured to couple to the grinding section, and the rotor is disposed in the additional sidewall.

20. The grinder of claim 16, wherein the grinding section comprises:
a surface coupled to the sidewall; and
a plurality of bumps extending from the surface and configured to interact with the substance to grind the substance.
